(19) United States
(12) Patent Application Publication
(10) Pub. No.: US 2024/0294060 A1
(43) Pub. Date: Sep. 5, 2024

(54) Motor Vehicle Having a Body and a Drive Energy Accumulator

(71) Applicant: Bayerische Motoren Werke Aktiengesellschaft, Muenchen (DE)

(72) Inventors: Thomas HARSCH, Muenchen (DE); Michael KREITZ, Haimhausen (DE); Sebastian MAYR, Zusmarshausen (DE); Matthias WAGNER, Muenchen (DE)

(21) Appl. No.: 18/578,468

(22) PCT Filed: Jul. 21, 2022
(86) PCT No.: PCT/EP2022/070536

§ 371 Date: Jan. 11, 2024

(30) Foreign Application Priority Data
Jul. 23, 2021 (DE) 10 2021 119 166.1

(51) Int. Cl. B60K 1/04; B60L 50/60; B60L 50/64; B62D 21/03; B62D 25/20; H01M 50/204; H01M 50/242; H01M 50/249; H01M 50/262

(52) U.S. Cl. CPC B60K 1/04; B60L 50/64; B60L 50/66; B62D 21/03; B62D 25/20; H01M 50/204; H01M 50/242; H01M 50/249; H01M 50/262; B60K 2001/0438; H01M 2220/20

(57) ABSTRACT

A motor vehicle has a body and a drive energy accumulator. The motor vehicle can be a passenger motor vehicle or a truck, and particularly has an electric drive. The drive energy accumulator can be a drive battery which is also referred to as high-voltage accumulator. The body has a floor assembly with a left-hand longitudinal beam and a right-hand longitudinal beam. Such body longitudinal beams are also referred to as side sills or outer, lower longitudinal beams. The drive energy accumulator has a drive energy accumulator housing, and the drive energy accumulator or the drive energy accumulator housing is mounted to the floor assembly from below. The mounted drive energy accumulator or the mounted drive energy accumulator housing form at least part of a floor of the floor assembly.

### BACKGROUND AND SUMMARY

The present invention relates to a motor vehicle and a drive energy accumulator.

A motor vehicle with an electric drive usually has a drive battery which has a drive battery housing in which battery modules and battery cells, an electrical/electronic system, and a cooling device are arranged. The drive battery housing is in turn installed below a floor assembly on a vehicle body. The known drive battery housing is made, for example, from aluminum and has side beams, a cover, and a base. The side beams are designed, for example, as extruded profiles or cast parts.

As shown in DE 10 2017 223 407 A1, a known drive battery housing has longitudinal beams and a plurality of cross beams which run between the longitudinal beams. The drive battery housing moreover has an upper wall and a lower wall which are in each case connected at least to an outer beam structure. i.e. the outer longitudinal beams and the outer cross beams. The longitudinal beams and also the cross beams are formed from extruded profiles.

The object of the present invention is to provide a motor vehicle with a body and a drive energy accumulator, wherein the motor vehicle is lighter, has a greater range, and can be produced more cost-effectively.

This object is achieved by a motor vehicle in accordance with the independent claims. Advantageous embodiments of the invention are mentioned in the dependent patent claims.

The motor vehicle according to the invention has a body and a drive energy accumulator. The motor vehicle can be a car or a truck. In particular, the motor vehicle has an electric drive. The drive energy accumulator can be a drive battery (traction battery) which in particular is also referred to as a high-voltage accumulator. The body has a floor assembly with a left-hand longitudinal beam and a right-hand longitudinal beam. Such longitudinal beams of the body are also referred to as side sills or outer, lower longitudinal beams. The drive energy accumulator has a drive energy accumulator housing, wherein the drive energy accumulator or the drive energy accumulator housing is installed on the floor assembly from below. The installed drive energy accumulator or the installed drive energy accumulator housing, in particular a drive energy accumulator housing cover, form at least part of a floor of the floor assembly.

As a result, the drive energy accumulator housing replaces the floor of the floor assembly. As a result, the motor vehicle, i.e. the body, in particular the floor assembly, is lighter and requires fewer components. Moreover, a structural space in the vertical direction of the vehicle (Z direction) can be reduced as a result and higher battery cells can be installed.

The drive energy accumulator housing advantageously extends essentially over the whole width of the floor assembly, i.e. essentially over the whole structural space between the left-hand longitudinal beam and the right-hand longitudinal beam.

As a result, sufficient battery cells can be accommodated in the drive battery and a sufficiently large part of the floor of the floor assembly can be replaced.

The drive energy accumulator housing can moreover extend in a region or over as large a region as possible between a front axle and a rear axle of the motor vehicle. The drive energy housing advantageously extends from a front end wall (of a passenger compartment) or from below the front end wall to the front ends of a left-hand wheel arch and a right-hand wheel arch. The drive energy housing can moreover extend as far as below a second row of seats of the motor vehicle. In other words, the drive energy accumulator housing can extend and is arranged at least from a region between a front body pillar (an A-pillar) and a rear body pillar (in particular a C-pillar), wherein the drive energy accumulator housing extends from the region of the front body pillar as far as the region of the rear body pillar.

According to a preferred development of the present invention, the drive energy accumulator housing and the floor assembly interactively form a fluid-tight floor of a passenger compartment of the motor vehicle. In particular, the fluid-tightness of the passenger compartment in a downward direction is effected only by the interaction of the drive energy accumulator housing and the floor assembly-without the drive energy accumulator housing the floor assembly would not have a fluid-tight floor, and the floor assembly alone is not fluid-tight in a downward direction.

The drive energy accumulator housing thus replaces the function of a continuous fluid-tight floor of the floor assembly. Incidentally, in this context the term “fluid-tight” does not exclude that the floor assembly or the drive energy accumulator housing has openings, which can be closed by interaction with the floor assembly, for the passage of a cable, a water drain, or the like. “Fluid-tight” means in particular “liquid-tight”.

A seal or a sealing adhesive can be arranged suitably between the drive energy accumulator housing and the floor assembly such that the installed drive energy accumulator housing completely seals the floor assembly at the bottom.

The seal can be formed, for example, from butyl. The seal can be formed as a flat seal, a lip seal, or a profile seal.

The drive energy accumulator housing advantageously has a peripheral sealing flange which can also at the same time be a mounting flange, with a continuously peripheral sealing surface for sealing the drive energy accumulator housing with respect to the floor assembly.

The peripheral sealing flange is advantageously situated in a plane, i.e. in a plane parallel to an xy plane of a vehicle coordinate system. Sealing can be produced better as a result.

According to an advantageous development of the motor vehicle according to the invention, the floor assembly can have a front cross beam structure and a rear cross beam structure, wherein the drive energy accumulator housing is installed on the left-hand longitudinal beam and on the right-hand longitudinal beam as well as on the front cross beam structure and on the rear cross beam structure. The abovementioned sealing flange in this case bears against corresponding flange sealing surfaces of the longitudinal beams and the cross beam structures.

The floor assembly advantageously has, between the front cross beam structure and the rear cross beam structure, at least one further cross beam which is connected in each case to the left-hand longitudinal beam and the right-hand longitudinal beam or runs between the left-hand longitudinal beam and the right-hand longitudinal beam. The further cross beam can be a seat cross beam or a heel plate cross beam. The floor assembly advantageously has a plurality of further cross beams between which in each case a free space is formed such that the floor assembly is open at the bottom. The seat cross beam or beams is or are advantageously arranged in the region behind the end wall as far as a B-pillar and serve to fasten a front row of seats, i.e. front seats, and to provide impact resistance for the floor assembly in the transverse direction. The heel plate cross beam is usually arranged in the region of a front end of a second row of seats and serves to fasten the second row of seats as well as to provide impact resistance for the floor assembly in the transverse direction.

The drive energy accumulator housing is preferably installed on the further cross beam, in particular by means of a screw connection. Additionally or alternatively, the drive energy accumulator housing can be connected to the cross beam by an adhesive connection, i.e. be adhesively bonded.

As a result, the overall strength of the floor assembly with the drive energy accumulator housing can be further increased and oscillating behavior of the motor vehicle when driving can also be influenced positively. As a result, the drive energy accumulator housing moreover supports the cross beams and cross beam structures against bending in the event of a side impact.

According to a further development, the floor assembly does not have a floor plate between the front cross beam structure and the rear cross beam structure or between the front cross beam structure and a further cross beam-in other words, the floor assembly is advantageously formed with no floor plate or is free of a floor plate. A larger region of the floor assembly thus has an open form.

The term “has an open form” means that a free open region is formed which forms a through opening such that the floor assembly has an open form at the bottom.

Alternatively or additionally, the floor assembly can have, between the left-hand longitudinal beam and the right-hand longitudinal beam, at least one further longitudinal beam which is connected to the front cross beam structure and/or the rear cross beam structure. The further longitudinal beam can be arranged, for example, in the center and there form a central tunnel.

The floor assembly advantageously has no floor plate at all.

A floor plate is usually a single-shell component, in particular a flat component, optionally a single-layer component, which does not have or form a hollow profile or the like and therefore does not form a body beam.

40 to 85%, more advantageously 50 to 75%, and even more advantageously 55% to 70% of the surface area between the right-hand longitudinal beam and the left-hand longitudinal beam, as well as between the front cross beam structure and the rear cross beam structure, has an open form, i.e. with no floor plate and with no cross beam.

According to a development, an upper wall, i.e. an upper layer or an upper side, i.e. a side facing the passenger compartment, of the drive energy accumulator housing is formed as a heat exchanger for controlling the temperature of the drive energy accumulator, in particular of battery cells and/or electrical/electronic components. Additionally, the upper wall of the drive energy accumulator housing can be formed as a heat exchanger for controlling the temperature of the passenger compartment.

This is advantageous in this respect because battery cells of the drive energy accumulator, and also a passenger compartment, are heated in the case of cold outside temperatures and are cooled in the case of hot outside temperatures. The passenger compartment moreover has a temperature control system for the floor which is sufficiently advantageous for the temperature felt by occupants of the vehicle.

The drive energy accumulator can moreover have an additional housing which is arranged on the drive energy accumulator housing, i.e. on an upper side. The additional housing can be arranged below a vehicle seat, for example below a vehicle rear seat or a vehicle rear bench seat because additional structural space is available here in the vertical direction in the passenger compartment. Electrical/electronic components of the drive energy accumulator and/or further battery cells of the drive energy accumulator can be accommodated in the additional housing. The additional housing can be formed without the function as a floor plate such that only the drive energy accumulator housing cover has the floor plate function or replaces the floor plate. Alternatively, however, the additional housing can also replace or form a part of a floor plate of the floor assembly. In particular, the additional housing can form a rear floor of the floor assembly. The rear floor is the region below the vehicle rear seat or the vehicle rear bench seat. The additional housing is formed in particular by an upper wall of the drive energy accumulator housing, i.e. a drive energy accumulator housing cover, and by an additional housing cover which is placed over an outside of the upper wall and is connected to the outside of the upper wall. The additional housing or the components in the additional housing can likewise be temperature-controlled with the abovementioned heat exchanger.

An upper side of the drive energy accumulator housing can have as essentially plane form. As a result, production of the drive energy accumulator housing is simplified, in particular in terms of an arrangement of battery cells in the interior of the drive energy accumulator housing. Likewise, connection to the corresponding beams of the floor assembly and sealing between the drive energy accumulator housing and the floor assembly are simplified as a result. Lastly, a plane floor for the passenger compartment can advantageously be realized as a result.

The drive energy accumulator housing is preferably formed from a housing lower part and a housing upper part. The housing lower part advantageously has a housing lower part flange and the housing upper part has a housing upper part flange. The housing lower part and the housing upper part can be connected to each other via the housing lower part flange and the housing upper part flange. The housing upper part flange is moreover preferably formed for mounting the drive energy accumulator housing on the floor assembly and can likewise form a sealing flange.

According to a preferred development, the drive energy accumulator is designed and connected to the floor assembly in such a way that the drive energy accumulator increases the strength of the body when the motor vehicle is being driven and/or that the drive energy accumulator increases the strength of a body for the case where it is subject to an impact. The drive energy accumulator thus forms a supporting structural component installed on the body or the floor assembly. As a result, the floor assembly or the body can be designed as lighter because the drive energy accumulator assumes the function of a piece of the body structure.

The above described housing upper part of the drive energy accumulator housing can form the floor of the body. The above described heat exchanger can moreover be formed in the housing upper part.

The drive battery housing can be formed fluid-tightly.

The floor assembly has advantageously not formed a central tunnel. In this respect, a floor of the passenger compartment can advantageously have an essentially plane form.

Developments of the invention explained above can if possible and expedient be combined with one another as desired.

### BRIEF DESCRIPTION OF THE DRAWINGS

FIG. 1 shows schematically a perspective view of a motor vehicle with a body and a drive energy accumulator before mounting of the drive energy accumulator on the body according to an exemplary embodiment of the present invention.

FIG. 2 shows schematically a view in section of the motor vehicle with the body and the drive energy accumulator according to the exemplary embodiment of the present invention.

FIG. 3 shows schematically a perspective view from below of the motor vehicle with the body without the drive energy accumulator according to the exemplary embodiment of the present invention.

FIG. 4 shows schematically a perspective view from above of the motor vehicle with the body and the drive energy accumulator after mounting of the drive energy accumulator on the body according to the exemplary embodiment of the present invention.

### DETAILED DESCRIPTION OF THE DRAWINGS

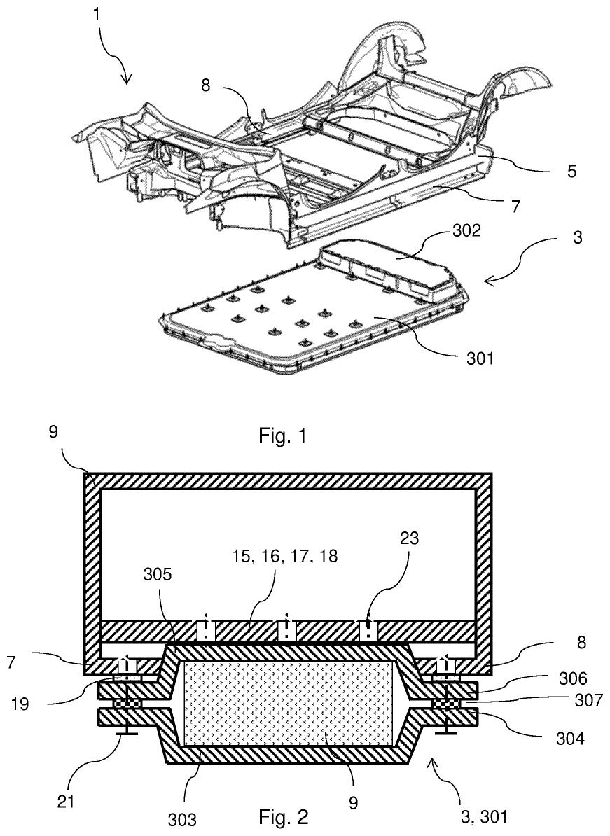

A description of an exemplary embodiment of the invention with reference to FIGS. 1 to 4 follows.

According to the exemplary embodiment of the present invention, a car has a body 1 and a drive energy accumulator 3. The drive energy accumulator 3 is a so-called high-voltage accumulator for driving an electric drive motor of the car, i.e. a drive battery. The state before mounting of the drive energy accumulator 3 on the body 1 is shown in FIG. 1. The body 1 is not completely illustrated in FIG. 1 and instead essentially just a floor assembly 5 of the body 1. The body 1 or the floor assembly 5 has a left-hand side sill 7 and a right-hand side sill 8, i.e. longitudinal beams according to the invention. The drive energy accumulator 3 has a drive energy accumulator housing 301 which has essentially the same height over its whole extent, and an additional housing 302 placed on it in the rear region of the drive energy accumulator 3. Battery cells 309 are essentially accommodated in the drive energy accumulator housing 301. A charger, a converter, and further electrical/electronic components are, for example, accommodated in the additional housing 302. The drive energy accumulator 3 is installed from below on the floor assembly 5 by means of screw connections and possibly additionally by adhesive connections.

A highly schematic view in section in a y direction and a z direction of the body 1 is shown in FIG. 2. The section runs through a passenger compartment 9 of the motor vehicle. The side sills 7, 8 on which the drive energy accumulator housing 301 is installed from below by means of screw connections 21 are shown at the bottom left and bottom right in FIG. 2. In particular, the drive energy accumulator housing 301 is installed on the floor assembly 5 at its peripheral flange 304, 306 with a seal 19 arranged in between. A further cross beam 15, 16, 17, 18 of the floor assembly 5 is moreover illustrated schematically in the view in section. The drive energy accumulator housing 301 is connected and additionally adhesively bonded to the further cross beam 15, 16, 17, 18 by means of screw connections 23.

The installed drive energy accumulator housing 301 forms at least part of a floor of the floor assembly 5 and extends over the whole width of the floor assembly 5 between the left-hand side sill 7 and the right-hand side sill 8. The passenger compartment 9 is sealed at the bottom by the seal 19.

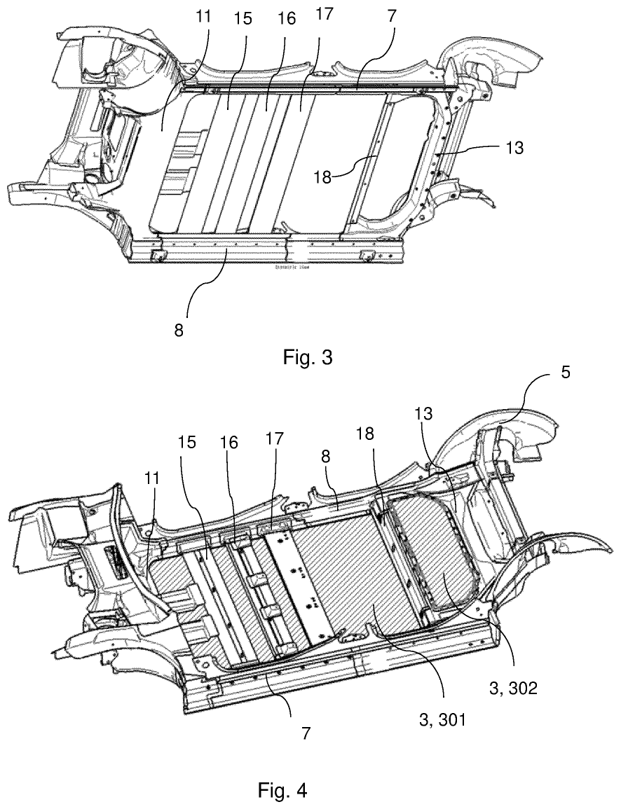

Just the floor assembly 5 without the drive energy accumulator 3 is shown in FIG. 3 in a perspective view from below. As shown in FIG. 3, the floor assembly 5 has, behind front wheel arches and behind a front axle, a front cross beam structure 11 with a so-called front end wall which delimits the passenger compartment at the front with respect to the front section of the vehicle and connects the front ends of the side sills 7 and 8 to each other. The floor assembly 5 moreover has, in front of rear wheel arches and in front of a rear axle, a rear cross beam structure 13 which connects rear ends of the side sills 7 and 8 to each other and which is arranged in the region of a rear bench seat (not illustrated) which forms a second row of seats of the motor vehicle. The floor assembly 5 moreover has, between the front cross beam structure 11 and the rear cross beam structure 13, further cross beams such as the seat cross beams 15, 16, 17 in the region of a front row of seats and a B-pillar of the body 1. A heel plate cross beam 18, which also forms a further cross beam within the sense of the invention, is arranged in the region of the rear row of seats. All the cross beams 15, 16, 17, 18 run between the left-hand side sill 7 and the right-hand side sill 8 and are connected thereto. The region between the side sills 7 and 8 and the respective cross beam structures 11 and 13 and the further cross beams 15, 16, 17, 18 is open. The floor assembly 5 is formed between these beams without a floor plate.

The floor assembly 5 with the assembled drive energy accumulator 3 is shown in a perspective view obliquely from above in FIG. 4. The hatched areas between the side sills 7 and 8 and the front cross beam structure 11 and the rear cross beam structure 13 of the floor assembly show an upper side of the drive energy accumulator 3, in particular of the drive energy accumulator housing 301 and the additional housing 302, in the open regions between the respective beams of the floor assembly 5. The upper side of the drive energy accumulator 3 forms a floor of the passenger compartment 9 in the hatched regions and thus replaces a conventional floor plate. As can moreover be seen in FIG. 4, the drive energy accumulator 3 extends from a front cross beam structure 11 with an end wall to a rear cross beam structure 13 which connects rear ends of the side sills 7 and 8 to each other, i.e. to a rear wheel arch of the floor assembly 3 underneath a rear bench seat which forms the second row of seats.

As a whole, a mounting sealing flange 306 running around the periphery of the drive energy accumulator housing 301 bears in sealing fashion against the corresponding constituent parts of the floor assembly 5 such that the drive energy accumulator housing 301 and the floor assembly 5 interactively form a fluid-tight floor of the passenger compartment 9 of the motor vehicle. The peripheral mounting sealing flange 306 is situated in a sealing plane in this exemplary embodiment.

Compared with a conventional floor assembly of a body, the floor assembly 5 does not have a floor plate and hence has free spaces between the adjacent cross beams/cross beam structures. These free spaces are closed by the drive energy accumulator housing 301—the additional housing 302 does not form a floor plate sealed to the body in this exemplary embodiment. In the present exemplary embodiment, 65% of the floor assembly 5 between the front cross beam structure 11 and the heel plate beam 18, without the drive energy accumulator housing 301 between the side sills 7, 8 and the cross beam structures 11 and 13, is open at the bottom.

The drive energy accumulator 3 has, in addition to the drive energy accumulator housing 301, the additional housing 302 which is placed on the drive energy accumulator housing 301 in the rear region of the drive energy accumulator housing 301, in the region below the rear bench seat, i.e. behind the heal plate cross beam 18. Chargers, converters, and other electrical and electronic components of the drive energy accumulator 3 are accommodated in the additional housing 302. The additional housing 302 projects into the gap between the heel plate cross beam 18 and the rear cross beam structure 13. An upper side of the drive energy accumulator housing 301 has an essentially plane form. As can be seen in FIG. 2, it is formed from a housing lower part 303 and a housing upper part 305, wherein the housing lower part 303 has a housing lower part flange 304 and the housing upper part 305 has a housing upper part flange 306, wherein the housing lower part 303 and the housing upper part 305 are connected to each other via the housing lower part flange 304 and the housing upper part flange 306, and wherein the housing upper part flange 306 is formed for mounting the drive energy accumulator housing 303 on the floor assembly 5. A seal 307 is arranged between the housing upper part flange 306 and the housing lower part flange 304. A seal 19 is moreover arranged between the housing upper part flange 306 and the floor assembly 5.

The drive energy accumulator housing 301 is connected to the floor assembly 5 via the screw connections 21 via the mounting sealing flange 304, 306. The drive energy accumulator housing 301 and the housing upper part 305 are moreover connected to the cross beams 15, 16, 17, 18 via the screw connections 23.

1.-13. (canceled)

14. A motor vehicle, comprising:
a body; and
a drive energy accumulator, wherein
the body has a floor assembly with a left-hand longitudinal beam and a right-hand longitudinal beam,
the drive energy accumulator has a drive energy accumulator housing,
the drive energy accumulator housing is installed on the floor assembly from below, and
the installed drive energy accumulator housing forms at least part of a floor of the floor assembly.

15. The motor vehicle according to claim 14, wherein
the drive energy accumulator housing and the floor assembly interactively form a fluid-tight floor of a passenger compartment of the motor vehicle,
the fluid-tightness of the floor of the passenger compartment is effected only by interaction of the drive energy accumulator housing and the floor assembly.

16. The motor vehicle according to claim 14, wherein
the drive energy accumulator housing has a peripheral sealing flange with a continuously peripheral sealing surface for sealing the drive energy accumulator housing with respect to the floor assembly.

17. The motor vehicle according to claim 14, wherein
the floor assembly has a front cross beam structure and a rear cross beam structure,
the drive energy accumulator housing is installed on the left-hand longitudinal beam and on the right-hand longitudinal beam as well as on the front cross beam structure and on the rear cross beam structure.

18. The motor vehicle according to claim 17, wherein
the floor assembly has, between the front cross beam structure and the rear cross beam structure, at least one further cross beam which is connected to the left-hand longitudinal beam and/or the right-hand longitudinal beam, and/or
the floor assembly has, between the left-hand longitudinal beam and the right-hand longitudinal beam, at least one further longitudinal beam which is connected to the front cross beam structure and/or the rear cross beam structure.

19. The motor vehicle according to claim 18, wherein
the further crossbeam is a seat cross beam and/or a heel plate cross beam.

20. The motor vehicle according to claim 18, wherein
the drive energy accumulator housing is installed on the further cross beam via a screw connection, and/or
the drive energy accumulator housing is adhesively bonded to the further cross beam.

21. The motor vehicle according to claim 17, wherein
the floor assembly does not have a floor plate between the front cross beam structure and the rear cross beam structure or between the front cross beam structure and a further cross beam, whereby a large region of the floor assembly has an open form.

22. The motor vehicle according to claim 21, wherein
40% to 85% of a surface area between the right-hand longitudinal beam and the left-hand longitudinal beam, as well as between the front cross beam structure and the rear cross beam structure, has an open form.

23. The motor vehicle according to claim 14, wherein
an upper wall of the drive energy accumulator housing is formed as a heat exchanger for controlling a temperature of the drive energy accumulator, and
the upper wall of the drive energy accumulator housing is formed additionally as a heat exchanger for controlling the temperature of the passenger compartment.

24. The motor vehicle according to claim 14, wherein
the drive energy accumulator has an additional housing which is arranged on the drive energy accumulator housing and in which an electrical/electronic system and/or further battery cells of the drive energy accumulator is/are accommodated, and
the additional housing is arranged below a vehicle seat.

25. The motor vehicle according to claim 14, wherein
an upper side of the drive energy accumulator housing has an essentially planar form.

26. The motor vehicle according to claim 14, wherein
the drive energy accumulator housing is formed from a housing lower part and a housing upper part,
the housing lower part has a housing lower part flange and the housing upper part has a housing upper part flange,
the housing lower part and the housing upper part are connected to each other via the housing lower part flange and the housing upper part flange, and
the housing upper part flange or the housing lower part flange together with the housing upper part flange, is formed for mounting the drive energy accumulator housing on the floor assembly.

27. The motor vehicle according to claim 14, wherein
the drive energy accumulator is connected to the floor assembly so as to increase a strength of the body when the motor vehicle is being driven and so as to increase a strength of the body for a case where the vehicle is subject to an impact.
